(19) United States
(12) Patent Application Publication
(10) Pub. No.: US 2020/0151668 A1
(43) Pub. Date: May 14, 2020

(54) INFORMATION PROCESSING DEVICE, FLYING OBJECT, TRANSPORT NETWORK GENERATION METHOD, TRANSPORT METHOD, PROGRAM, AND RECORDING MEDIUM

(71) Applicant: SZ DJI TECHNOLOGY CO., LTD., Shenzhen (CN)

(72) Inventors: Lei GU, Shenzhen (CN); Xiangwei WANG, Shenzhen (CN)

(21) Appl. No.: 16/739,900

(22) Filed: Jan. 10, 2020

Related U.S. Application Data
(63) Continuation of application No. PCT/CN2017/117509, filed on Dec. 20, 2017.

(30) Foreign Application Priority Data
Jul. 11, 2017 (JP) 2017-135590

(51) Int. Cl. G06Q 10/08; G06T 17/20; B64C 39/02; B64D 1/12; G05D 1/10

(52) U.S. Cl. CPC G06Q 10/08355; G06Q 10/0832; G06Q 10/0833; B64C 2201/128; B64C 39/024; B64D 1/12; G05D 1/106; G06T 17/20

(57) ABSTRACT

An information processing device for generating a transport network for transporting a cargo by a flying object is provided in the present disclosure. The information processing device includes a processing element for performing a processing related to a generation of the transport network. The processing element is configured to acquire information of three-dimensional positions of each of a plurality of bases located on a ground in a transport region with the cargo to be transported, and further configured to, by adding a predetermined height to the three-dimensional positions of each of the plurality of bases, calculate three-dimensional positions of each of a plurality of air passing-nodes for the flying object to fly through. The processing element is further configured to generate a plurality of transportable paths capable of transporting the cargo by connecting the plurality of air passing-nodes, and also generate the transport network according to the three-dimensional positions of each of the plurality of air passing-nodes and the plurality of transportable paths.

### CROSS-REFERENCE TO RELATED APPLICATION

This application is a continuation of International Application No. PCT/CN2017/117509, filed on Dec. 20, 2017, which claims priority to JP Patent No. 2017-135590, filed on Jul. 11, 2017, the entire content of all of which is incorporated herein by reference.

### TECHNICAL FIELD

The present disclosure relates to an information processing device, a transport network generation method, a program, and a recording medium for generating a transport network for transporting cargoes through a flying object. The present disclosure relates to a flying object, a transport method, a program, and a recording medium for transporting cargoes.

### BACKGROUND

Conventionally, a known flight distribution system may include a flight distribution aircraft capable of distributing cargoes and a management device capable of remotely operating the flight distribution aircraft. A label indicating a distribution place may be displayed in such place located at a destination for the cargoes to be distributed. The flight distribution aircraft may include a flight status control element, a capturing element, and a recognition element. The flight status control element is configured to control flight status according to instructions from the management device. The capturing element is configured to capture labels. The recognition element is configured to identify the labels in captured images photographed by the capturing element. When the labels are recognized from the captured images by the recognition element, the flight status control element may control the flight status of the flight distribution aircraft, thereby moving to redistribution-capable positions based on the captured labels.

### SUMMARY

In accordance with the disclosure, an information processing device is provided in the present disclosure. The information processing device includes a processing element for performing a processing related to a generation of the transport network. The processing element is configured to acquire information of three-dimensional positions of each of a plurality of bases located on a ground in a transport region with the cargo to be transported, and further configured to, by adding a predetermined height to the three-dimensional positions of each of the plurality of bases, calculate three-dimensional positions of each of a plurality of air passing-nodes for the flying object to fly through. The processing element is further configured to generate a plurality of transportable paths capable of transporting the cargo by connecting the plurality of air passing-nodes, and also generate the transport network according to the three-dimensional positions of each of the plurality of air passing-nodes and the plurality of transportable paths.

Also in accordance with the disclosure, a method for generating a transport network is provided in the present disclosure. The method for generating the transport network includes acquiring information of three-dimensional positions of each of a plurality of bases located on a ground in a transport region with the cargo to be transported; by adding a predetermined height to the three-dimensional positions of each of the plurality of bases, calculating three-dimensional positions of each of a plurality of air passing-nodes for the flying object to fly through; generating a plurality of transportable paths capable of transporting the cargo by connecting the plurality of air passing-nodes; and generating the transport network according to the three-dimensional positions of each of the plurality of air passing-nodes and the plurality of transportable paths.

Also in accordance with the disclosure, a transport method is provided in the present disclosure. The transport method includes acquiring position information of a transport source and a final transport destination of the cargo; acquiring information of a transport network according to the transport network, the position information of the transport source and the final transport destination, generating a transport path from the transport source to the final transport destination; and acquiring position information of a transport destination of the cargo according to the transport path, thereby enabling the flying object to transport the cargo to the transport destination.

### BRIEF DESCRIPTION OF THE DRAWINGS

FIG. 1 illustrates a schematic of a configuration of a transport network generation system according to some embodiments of the present disclosure;

FIG. 2 illustrates a block diagram of a hardware configuration of an unmanned aerial vehicle according to some embodiments of the present disclosure;

FIG. 3 illustrates a block diagram of a hardware configuration of a mobile terminal according to some embodiments of the present disclosure;

FIG. 4 illustrates a block diagram of a hardware configuration of a personal computer (PC) according to some embodiments of the present disclosure;

FIG. 5 illustrates a diagram of an arrangement of bases in a mountain region according to some embodiments of the present disclosure;

FIG. 6 illustrates a diagram of an arrangement of bases and air passing-nodes in a mountain region according to some embodiments of the present disclosure;

FIG. 7 illustrates a diagram of a transport network in a mountain region according to some embodiments of the present disclosure;

FIG. 8 illustrates a diagram of a transport network with deleted sidelines in a mountain region according to some embodiments of the present disclosure;

FIG. 9 illustrates a diagram of a transport network of a ground conflict with sidelines according to some embodiments of the present disclosure;

FIG. 10 illustrates a diagram of a modified transportable path of a ground conflict with sidelines according to a modified embodiment of the present disclosure;

FIG. 11 illustrates a diagram of a transport network with an added transit node in a mountain region according to some embodiments of the present disclosure;

FIG. 12 illustrates a flow chart of operations when generating a transport network by a mobile terminal according to some embodiments of the present disclosure;

FIG. 13 illustrates a diagram of a transport network acquired by an unmanned aerial vehicle according to some embodiments of the present disclosure;

FIG. 14 illustrates a diagram of a transport path according to some embodiments of the present disclosure;

FIG. 15 illustrates a stereoscopic schematic of a cargo holding form of an unmanned aerial vehicle according to some embodiments of the present disclosure; and

FIG. 16 illustrates a flow chart of operations when transporting a cargo by an unmanned aerial vehicle according to some embodiments of the present disclosure.

### DETAILED DESCRIPTION OF THE EMBODIMENTS

Hereinafter, the present disclosure is described with embodiments of the present disclosure, but the following embodiments do not limit the present disclosure according to the claims. Not all combinations of features described in the embodiments are necessary for the solutions of the present disclosure.

The claims, the specification, the drawings of the specification, and the abstract of the specification include matters that are protected by copyright. As long as anyone reproduces these documents as indicated by the patent office's documents or records, the copyright owner cannot object. However, in all other cases, all copyrights are reserved.

In the following embodiments, a flying object is an unmanned aerial vehicle (UAV) as an example. The flying object may include an aircraft moving in the air. In the drawings of the specification, the unmanned aerial vehicle is marked as “UAV”. Furthermore, an information processing device is a personal computer (PC) as an example. In addition, the information processing device may be a device other than the PC, and may be, for example, a mobile terminal, a transmitter, a flying object, a server device or other devices. A transport network generation method may specify operations in the information processing device. A transport method may specify operations in the flying object. A recording medium may store programs (e.g., programs for the information processing device to execute various processing or programs for the flying object to execute various processing).

First Implementation Manner

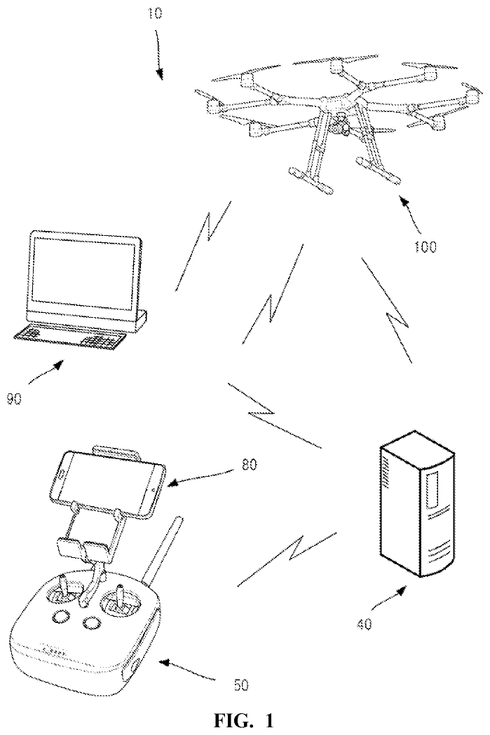

FIG. 1 illustrates a schematic of a configuration of a transport network generation system according to some embodiments of the present disclosure. A flight system 10 may include an unmanned aerial vehicle 100, a transmitter 50, a mobile terminal 80, a PC 90, and a transport server 40. The unmanned aerial vehicle 100, the transmitter 50, the mobile terminal 80, the PC 90, and the transport server 40 may communicate with each other through wired communication or wireless communication (e.g., a wireless local region network).

The unmanned aerial vehicle 100 may fly according to remote operations performed by the transmitter 50 or may fly according to a set flight path. The unmanned aerial vehicle 100 may perform the processing related to cargo transportation. The cargo transportation may include cargo aggregation and distribution.

The transmitter 50 may instruct the flight control of the unmanned aerial vehicle 100 through remote operations, that is, the transmitter 50 may operate as a remote controller. The transmitter 50 may be configured, for example, to adjust the flight position of the cargo transport during the flight according to the set flight path. The transmitter 50 may be carried by, for example, a transport client who uses the unmanned aerial vehicle 100 to transport cargos.

The mobile terminal 80 may input or prompt (e.g., display and voice output) information (transport information) related to cargo transport and information (cargo information) of the cargoes to be transported. The mobile terminal 80 may be carried by, for example, a transport client who uses the unmanned aerial vehicle 100 to transport cargos. The mobile terminal 80 may be used integrally with the transmitter 50 or may be used separately from the transmitter 50. In addition, functions of the mobile terminal 80 may be implemented by other information processing devices.

The PC 90 may execute processing related to the transport network generation for transporting cargoes. The PC 90 may be disposed at, for example, a headquarter of a transportation company and a transport base (also referred to as a base). In addition, functions of the PC 90 may be implemented by other information processing devices.

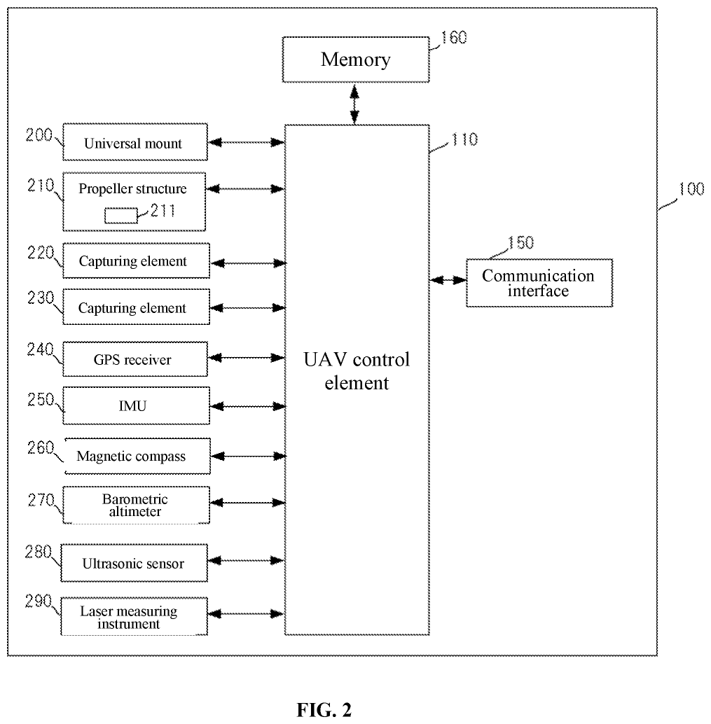

FIG. 2 illustrates a block diagram of a hardware configuration of the unmanned aerial vehicle according to some embodiments of the present disclosure. The unmanned aerial vehicle 100 may include a UAV control element 110, a communication interface 150, a memory 160, a gimbal 200, a propeller structure 210, a capturing element 220, a capturing element 230, a GPS receiver 240, an inertial measurement unit (IMU) 250, a magnetic compass 260, a barometric altimeter 270, an ultrasonic sensor 280, and a laser measuring instrument 290.

The UAV control element 110 may include, for example, a central processing unit (CPU), a micro processing unit (MPU), or a digital signal processor. The UAV control element 110 may be configured to overall control signal processing of operations of each part of the unmanned aerial vehicle 100, and data input output processing, data computation processing and data storage processing between parts of the unmanned aerial vehicle 100 and other external parts.

The UAV control element 110 may control the flight of the unmanned aerial vehicle 100 according to programs stored in the memory 160. The UAV control element 110 may perform the processing related to the cargo transport. The UAV control element 110 may control the flight of the unmanned aerial vehicle 100 according to instructions received from the remote transmitter 50 through the communication interface 150.

The UAV control element 110 may acquire position information indicating the position of the unmanned aerial vehicle 100. The UAV control element 110 may acquire the position information indicating the latitude, longitude and height of the unmanned aerial vehicle 100 from the GPS receiver 240. The UAV control element 110 may respectively acquire the latitude and longitude information indicating the latitude and longitude of the unmanned aerial vehicle 100 from the GPS receiver 240 and the height information indicating the height of the unmanned aerial vehicle 100 from the barometric altimeter 270, where the latitude, longitude and height information may be configured as the position information. The UAV control element 110 may acquire a distance between an emission point of the ultrasonic wave and a reflection point of the ultrasonic wave of the ultrasonic sensor 280, where the distance may be configured as the height information.

The UAV control element 110 may acquire orientation information indicating the orientation of the UAV 100 from the magnetic compass 260. The orientation information may be represented by, for example, an orientation corresponding to a direction of the nose of the unmanned aerial vehicle 100.

The UAV control element 110 may acquire the position information indicating positions that the unmanned aerial vehicle 100 should be present when the capturing element 220 performs capturing on a capturing range to be captured. The UAV control element 110 may acquire the position information of the positions that the unmanned aerial vehicle 100 should be present from the memory 160. The UAV control element may acquire the position information of the positions that the unmanned aerial vehicle 100 should be present from other devices through the communication interface 150. The UAV control element 110 may particularly specify the positions that the unmanned aerial vehicle 100 may be present by referring a three-dimensional map database, thereby acquiring the positions which are configured as the position information of the positions that the unmanned aerial vehicle 100 should be present.

The UAV control element 110 may acquire the capturing range information respectively indicating capturing ranges of the capturing element 220 and the capturing element 230. The UAV control element 110 may acquire viewing angle information indicating viewing angles of the capturing element 220 and the capturing element 230 from the capturing element 220 and the capturing element 230, and the viewing angle information may be configured to particularly specify parameters of the capturing ranges. The UAV control element 110 may acquire the information indicating the capturing directions of the capturing element 220 and the capturing element 230, and the capturing direction information may be configured to particularly specify parameters of the capturing ranges. The UAV control element 110 may acquire attitude information indicating the attitude state of the capturing element 220 from the gimbal 200, and the attitude information may be configured to be capturing direction information of the capturing element 220. The attitude information of the capturing element 220 may be represented as angles that the gimbal 200 rotates from reference rotation angles of a pitch axis and a yaw axis.

The UAV control element 110 may acquire the position information indicating the position where the unmanned aerial vehicle 100 is located, and the position information may be configured to particularly specify the parameter for the capturing range. The UAV control element 110 may determine the capturing range indicating the capturing geographic range of the capturing element 220 and generate the capturing range information according to the viewing angles and capturing directions of the capturing element 220 and the capturing element 230, and also the position of the unmanned aerial vehicle 100, thereby acquiring the capturing range information.

The UAV control element 110 may acquire the capturing information indicating the capturing range which should be captured by the capturing element 220. The UAV control element 110 may acquire the capturing information which should be captured by the capturing element 220 from the memory 160. The UAV control element 110 may acquire the capturing information which should be captured by the capturing element 220 from other devices through the communication interface 150.

The UAV control element 110 may control the gimbal 200, the propeller structure 210, the capturing element 220 and the capturing element 230. The UAV control element 110 may control the capturing range of the capturing element 220 by changing the capturing direction or viewing angle of the capturing element 220. The UAV control element 110 may control the capturing range of the capturing element 220 supported by the gimbal 200 by controlling the rotation structure of the gimbal 200.

The capturing range may refer to the capturing geographic range of the capturing element 220 and the capturing element 230. The capturing range may be defined by latitude, longitude and height. The capturing range may be a range of three-dimensional spatial data defined by latitude, longitude and height. The capturing range may be particularly specified according to the viewing angles and capturing directions of the capturing element 220 or the capturing element 230, and the position of the unmanned aerial vehicle 100. The capturing directions of the capturing element 220 and the capturing element 230 may be defined by front orientations and front depression angles of capturing lenses of the capturing element 220 and the capturing element 230. The capturing direction of the capturing element 220 may be a direction particularly specified by the orientation of the nose of the unmanned aerial vehicle 100 and the attitude state of the capturing element 220 relative to the gimbal 200. The capturing direction of the capturing element 230 may be a direction particularly specified by the orientation of the nose of the unmanned aerial vehicle 100 and the configured position of the capturing element 230.

The UAV control element 110 may particularly specify the environment around the unmanned aerial vehicle 100 by analyzing a plurality of images captured by a plurality of capturing elements 230. The UAV control element 110 may avoid obstacles according to the environment around the UAV 100 to control flight.

The UAV control element 110 may acquire the stereoscopic information (three-dimensional information) indicating stereoscopic shapes (three-dimensional shapes) of objects existing around the unmanned aerial vehicle 100. The objects may part of a landscape such as a building, a road, a car, a tree, and the like. The stereoscopic information may be, for example, three-dimensional spatial data. The UAV control element 110 may acquire the stereoscopic information by generating the stereoscopic information indicating the stereoscopic shapes of objects existing around the unmanned aerial vehicle 100 from each image obtained by the plurality of capturing elements 230. The UAV control element 110 may acquire the stereoscopic information indicating the stereoscopic shapes of objects existing around the unmanned aerial vehicle 100 by referring to the three-dimensional map database stored in the memory 160. The UAV control element 110 may acquire the stereoscopic information indicating the stereoscopic shapes of objects existing around the unmanned aerial vehicle 100 by referring to the three-dimensional map database managed by servers existing on a network.

The UAV control element 110 may control the flight of the unmanned aerial vehicle 100 by controlling the propeller structure 210. That is, the UAV control element 110 may control the position including the latitude, longitude, and height of the unmanned aerial vehicle 100 by controlling the propeller structure 210. The UAV control element 110 may control the capturing range of the capturing element 220 by controlling the flight of the unmanned aerial vehicle 100. The UAV control element 110 may control the viewing angle of the capturing element 220 by controlling a zoom lens included in the capturing element 220. The UAV control element 110 may use the digital zoom function of the capturing element 220 to control the viewing angle of the capturing element 220 through the digital zoom.

When the capturing element 220 is fixed to the unmanned aerial vehicle 100 and may not be moved, the UAV control element 110 may move the unmanned aerial vehicle 100 to a particularly specified position on a particularly specified date and time, thus the capturing element 220 may perform capturing at an expected capturing range in an expected environment. Or, even in a case where the capturing element 220 may not have a zoom function, and the viewing angle of the capturing element 220 may not be changed, the UAV control element 110 may also move the unmanned aerial vehicle 100 to a particularly specified position on a particularly specified date and time, thus the capturing element 220 may perform capturing at an expected capturing range in an expected environment.

The communication interface 150 may communicate with the transmitter 50, the mobile terminal 80, the PC 90, and the transport server 40. The communication interface 150 may perform wireless communication or wired communication through any wireless or wired communication methods.

The memory 160 may store programs and the like for the UAV control element 110 to control the gimbal 200, the propeller structure 210, the capturing element 220, the capturing element 230, the GPS receiver 240, the inertial measurement unit 250, the magnetic compass 260, the barometric altimeter 270, the ultrasonic sensor 280, and the laser measuring instrument 290. The memory 160 may be a computer-readable medium, including at least one of a static random-access memory (SRAM), a dynamic random-access memory (DRAM), an erasable programmable read only memory (EPROM), an electrically erasable programmable read-only memory (EEPROM), and a flash memory such as a universal serial bus (USB) memory. The memory 160 may further include any one of various memories such as a hard disk drive (HDD), a solid-state drive (SSD), a secure digital (SD) card, and the like. The memory 160 may store various information and data acquired from the communication interface 150. The memory 160 may also be removed from the unmanned aerial vehicle 100.

The gimbal 200 may rotatably support the capturing element 220 around the yaw axis, the pitch axis, and the roll axis. The gimbal 200 may change the capturing direction of the capturing element 220 by rotating the capturing element 220 around at least one of the yaw axis, the pitch axis, and the roll axis.

The yaw axis, the pitch axis, and the roll axis may be determined as the following. For example, the roll axis may be defined as a horizontal direction (a direction parallel with the ground). In such case, the pitch axis may be determined as a direction parallel with the ground and perpendicular to the roll axis; and the yaw axis (refer to a z axis) may be determined as a direction perpendicular to the ground and also perpendicular to the roll axis and the pitch axis.

The propeller structure 210 may have a plurality of propellers 211 and a plurality of drive motors which drive the plurality of propellers 211 to rotate. The propellers 211 may be controlled to rotate by the UAV control element 110, thereby flying the unmanned aerial vehicle 100. The quantity of propellers 211 may be, for example, eight, or other quantities. In addition, the unmanned aerial vehicle 100 may be a fixed-wing aircraft without propellers.

Furthermore, the more the quantity of propellers is, the greater the removing force obtained by the unmanned aerial vehicle 100 is. Therefore, the more the quantity of propellers is, the more and heavier cargoes the unmanned aerial vehicle 100 may handle, that is, the loadable capacity may be determined according to the quantity of propellers 211.

The capturing element 220 may be a camera performing capturing on an object included in an expected capturing range (e.g., the sky above an aerial capturing target, a landscape such as a mountain and a river, and a building on the ground). The capturing element 220 may capture images of a subject in an expected capturing range and generate data of captured images. The image data obtained by the capturing element 220 may be stored in a memory or the memory 160 included in the capturing element 220.

The capturing element 230 may be a sensing camera that capture the surrounding of the unmanned aerial vehicle 100 to control the flight of the unmanned aerial vehicle 100. Two capturing elements 230 may be disposed on the front (the nose) of the unmanned aerial vehicle 100, and the other two capturing elements 230 may be disposed at the bottom of the unmanned aerial vehicle 100. Two capturing elements 230 on the front side may be paired to function as a so-called stereo camera. Two capturing elements 230 on the bottom side may also be paired to function as a so-called stereo camera. The three-dimensional spatial data (three-dimensional shape data) around the unmanned aerial vehicle 100 may be generated from images captured by the plurality of capturing elements 230. In addition, the quantity of the capturing elements 230 included in the unmanned aerial vehicle 100 may not be limited to four. The unmanned aerial vehicle 100 may include at least one capturing element 230. The unmanned aerial vehicle 100 may include at least one capturing element 230 respectively at the nose, the tail, the side, the bottom and the top of the unmanned aerial vehicle 100. The configurable viewing angle of the capturing element 230 may be larger than the configurable viewing angle of the capturing element 220. The capturing element 230 may include a single focus lens or a fisheye lens. The capturing element 230 may capture the surrounding of the unmanned aerial vehicle 100 and generate the data of the capture images. The image data of the capturing element 230 may be stored in the memory 160.

The GPS receiver 240 may receive a plurality of signals representing time transmitted by a plurality of navigation satellites (e.g., GPS satellites) and the position (coordinate) of each GPS satellite. The GPS receiver 240 may calculate the position of the GPS receiver 240 (i.e., the position of the unmanned aerial vehicle 100) according to the plurality of received signals. The GPS receiver 240 may output the position information of the unmanned aerial vehicle 100 to the UAV control element 110. In addition, the UAV control element 110, instead of the GPS receiver 240, may be configured to calculate the position information of the GPS receiver 240. In such case, the plurality of signals received by the GPS receiver 240 including the time and the position information of each GPS satellite may be inputted into the UAV control element 110.

The inertial measurement device 250 may detect the attitude of the unmanned aerial vehicle 100 and output the detection result into the UAV control element 110. The inertial measurement device 250 may detect the accelerations of three axis directions of the front-rear, left-right, and up-down, and the angular velocities of three axis directions of the pitch axis, the roll axis, and the yaw axis of the unmanned aerial vehicle 100, which may be used as the attitude of the unmanned aerial vehicle 100.

The magnetic compass 260 may detect the orientation of the nose of the unmanned aerial vehicle 100 and output the detection result to the UAV control element 110.

The barometric altimeter 270 may detect the flight height of the unmanned aerial vehicle 100 and output the detection result to the UAV control element 110. In addition, a sensor other than the barometric altimeter 270 may also be used to detect the flight height of the unmanned aerial vehicle 100.

The ultrasonic sensor 280 may transmit ultrasonic waves, detect ultrasonic waves reflected from the ground and an object, and output the detection result into the UAV control element 110. The detection result may indicate a distance from the unmanned aerial vehicle 100 to the ground, that is, the height. The detection result may also indicate a distance from the unmanned aerial vehicle 100 to an object (a subject to be captured).

The laser measuring instrument 290 may irradiate laser light to an object, receive the light reflected by the object, and measure a distance between the unmanned aerial vehicle 100 and the object (a subject to be captured) through the reflected light. A time-of-flight method may be used as an example of the laser-based distance measurement method.

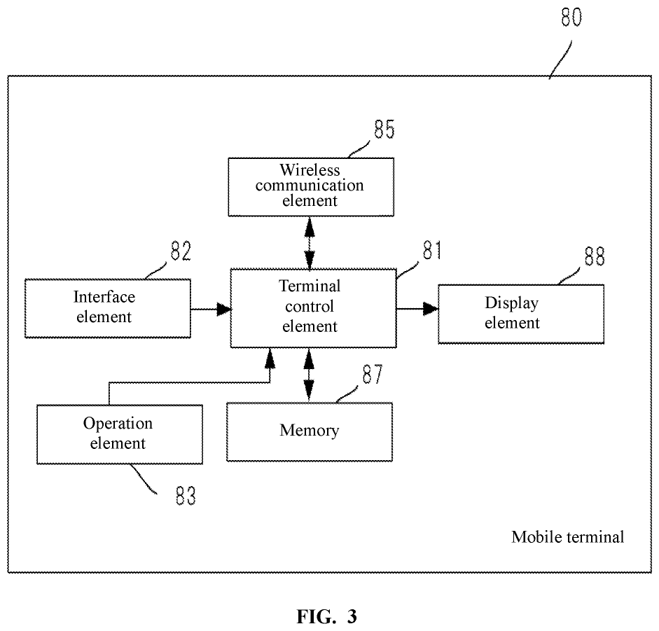

FIG. 3 illustrates a block diagram of a hardware configuration of the mobile terminal according to some embodiments of the present disclosure. The mobile terminal 80 may include a terminal control element 81, an interface element 82, an operation element 83, a wireless communication element 85, a memory 87, and a display element 88.

The terminal control element 81 may include, for example, a CPU, an MPU or a DSP. The terminal control element 81 may be configured to overall control signal processing of operations of each part of the terminal control element 81, and data input output processing, data computation processing and data storage processing between parts of the terminal control element 81 and other parts.

The terminal control element 81 may acquire the data and information of the unmanned aerial vehicle 100 through the wireless communication element 85. The terminal control element 81 may also acquire the data and information of the unmanned aerial vehicle 100 through the interface element 82. The terminal control element 81 may also acquire the data and information (e.g., transport information and cargo information) inputted from the operation element 83. The terminal control element 81 may acquire the data and information stored in the memory 87. The terminal control element 81 may transmit the data and information (e.g., transport information and cargo information) to the transport server 40 through the wireless communication element 85. The terminal control element 81 may transmit the data and information (e.g., transport information and cargo information) to the display element 88, thus the display information based on the data and information may be displayed on the display element 88.

The transport information may include, for example, information of a transport source, information of a final transport destination, and information of a consignee of the final transport destination. The information of the transport source may include the information of a transport client (a cargo aggregation client), a cargo aggregation (scheduled) time, and a location of the transport source (a cargo aggregation location). The final transport destination may include the information of a distribution (scheduled) time, a location (distribution location) of the final transport destination, and a consignee of the final transport destination. The cargo information may include information such as owners, colors, sizes, shapes, and weights of the cargoes. The owner of the cargo may be the same as the transport client.

The terminal control element 81 may execute transport support application programs. The transport support application programs may have functions of inputting the transport information and cargo information related to the cargo transport performed by the unmanned aerial vehicle 100. The terminal control element 81 may generate various data used in the application programs.

The interface element 82 may perform input and output of the information and data between the transmitter 50 and the mobile terminal 80. The interface element 82 may perform input and output, for example, by a USB cable. The interface element 82 may be an interface other than USB interface.

The operation element 83 may receive and acquire the data and information inputted by a user of the mobile terminal 80. The operation element 83 may include buttons, keys, a touch display screen, a microphone, and the like. The operation element 83 and the display element 88 may include the touch display screen as an example herein. In such case, the operation element 83 may accept touch operations, click operations, drag operations, and the like.

The operation element 83 may accept the transport information and cargo information of the client cargo to be transported, and the transport indication information for indicating (or commissioning) the transport. The transport information, the cargo information, the transport indication information, and the like inputted by the operation element 83 may be transmitted to the unmanned aerial vehicle 100 and the transport server 40.

The wireless communication element 85 may perform wireless communication with the unmanned aerial vehicle 100 and the transport server 40 through various wireless communication manners. The wireless communication manners of the wireless communication may include, for example, the communication through a wireless LAN, a Bluetooth (registered trademark), or a public wireless network.

The memory 87 may include, for example, a ROM which stores programs for specifying operations and set value data of the mobile terminal 80, and a RAM which temporarily stores various information and data used by the terminal control element 81 for the processing. The memory 87 may also include memories other than the ROM and the RAM. The memory 87 may be configured inside the mobile terminal 80. The memory 87 may also be configured to be detachable from the mobile terminal 80. Programs may include application programs, and the memory 87 may also include various memories.

The display element 88 may include, for example, a liquid crystal display (LCD), for displaying various information and data outputted from the terminal control element 81. The display element 88 may display various information and data related to the execution of the transport support application programs.

In addition, the mobile terminal 80 may be mounted on the transmitter 50 through a bracket. The mobile terminal 80 and the transmitter 50 may be connected through a wired cable (e.g., a USB cable). The mobile terminal 80 may also not be mounted on the transmitter 50, and the mobile terminal 80 and the transmitter 50 may be separately disposed.

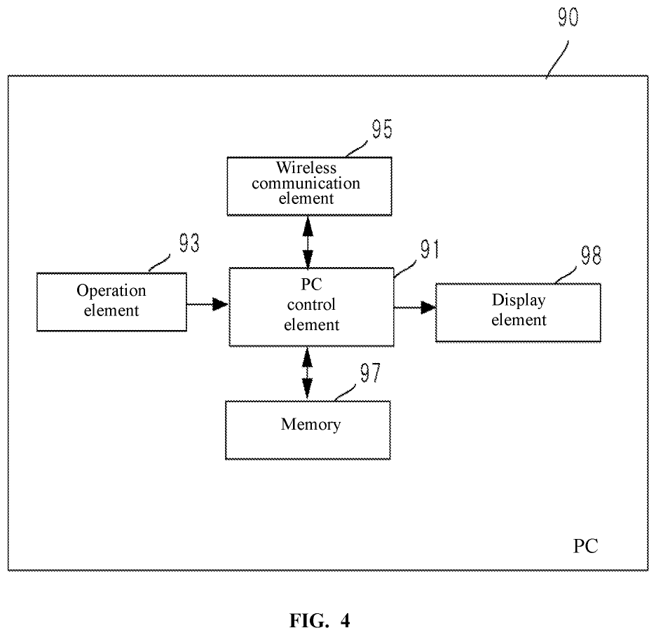

FIG. 4 illustrates a block diagram of a hardware configuration of a personal computer (PC 90) according to some embodiments of the present disclosure. The PC 90 may include a PC control element 91, an operation element 93, a wireless communication element 95, a memory 97, and a display element 98.

The PC control element 91 may include, for example, a CPU, an MPU, or a DSP. The PC control element 91 may be configured to overall control signal processing of operations of each part of the PC 90, and data input output processing, data computation processing and data storage processing between parts of the PC 90 and other parts.

The PC control element 91 may acquire the data and information of the unmanned aerial vehicle 100 through the wireless communication element 95. The PC control element 91 may acquire the data and information stored in the memory 97. The PC control element 91 may transmit data and information (e.g., transport network information) to the unmanned aerial vehicle 100 through the wireless communication element 95. The PC control element 91 may transmit data and information (e.g., transport network information and information related to transport network generation) to the display element 98, thus the display information based on the data and information may be displayed on the display element 98.

The PC control element 91 may execute transport support application programs. The transport support application programs may have functions of generating the transport information. The PC control element 91 may generate various data used in the application programs. The PC control element 91 may execute the processing related to the generation of the transport network.

The operation element 93 may receive and acquire the data and information inputted by a user (e.g., a transporter in charge) of the PC 90. The operation element 93 may include buttons, keys, a touch display screen, a microphone, and the like. The operation element 93 and the display element 98 may include the touch display screen as an example herein. In such case, the operation element 93 may accept touch operations, click operations, drag operations, and the like.

The wireless communication element 95 may perform wireless communication with the unmanned aerial vehicle 100 and the like through various wireless communication manners. The wireless communication manners of the wireless communication may include, for example, communication through a wireless LAN, a Bluetooth (registered trademark), or a public wireless network.

The memory 97 may include, for example, a ROM which stores programs for specifying operations and set value data of the PC 90, and a RAM which temporarily stores various information and date used by the PC control element 91 for processing. The memory 97 may also include memories other than the ROM and the RAM. The memory 97 may be configured inside the PC 90. The memory 97 may also be configured to be detachable from the PC 90. Programs may include application programs, and the memory 97 may also include various memories.

The display element 98 may include, for example, the liquid crystal display (LCD), for displaying various information and data outputted from the PC control element 91. The display element 98 may display various information and data related to the execution of the transport support application programs.

The flight system 10 may also not include the transmitter 50. In the flight system 10, the PC 90 may have the function of the mobile terminal 80, and the mobile terminal 80 may be omitted. In such case, the PC 90 may have the function of the mobile terminal 80 (e.g., the function related to the input of the transport information and the cargo information). In the flight system 10, the mobile terminal 80 may have the function of the PC 90, and the PC 90 may be omitted. In such case, the mobile terminal 80 may have the function of the PC 90 (e.g., the function of generating the transport network).

Next, the configuration of the transport server 40 may be exemplarily described as the following.

The transport server 40 may include a server control element, a wireless communication element, a memory, a storage device, and the like. The memory and the storage device may store base information in the transport region (e.g., base identification information and base three-dimensional position information), the transport information and the cargo information related to cargoes transport, and the like. The server control element may acquire the transport information, the cargo information, the transport indication information, and the like through the wireless communication element, and perform the processing required for the transport (e.g., the transmission of the transport information and the cargo information related to transport consignment to the unmanned aerial vehicle 100).

The Generation of the Transport Network

Next, the generation of the transport network may be exemplarily described as the following.

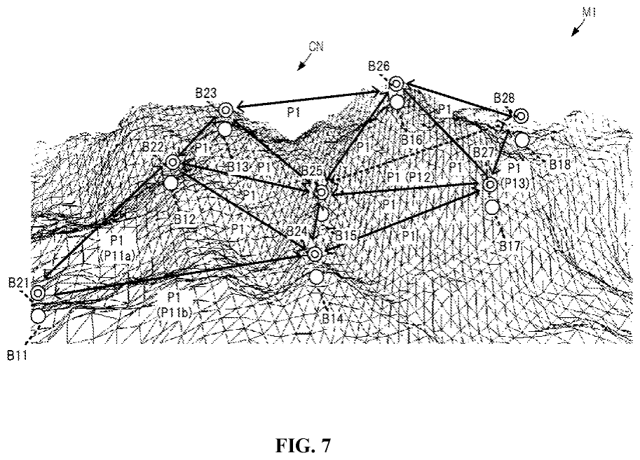

First, the functions of the PC control element 91 of the PC 90 related to the generation of the transport network CN may be described. The PC control element 91 may be an example of a processing element. The PC control element 91 may perform the processing related to the generation of the transport network CN (referring to FIG. 7 and the like). In addition, the processing for supporting the generation of the transport network CN by devices other than the PC 90 may also be described as required.

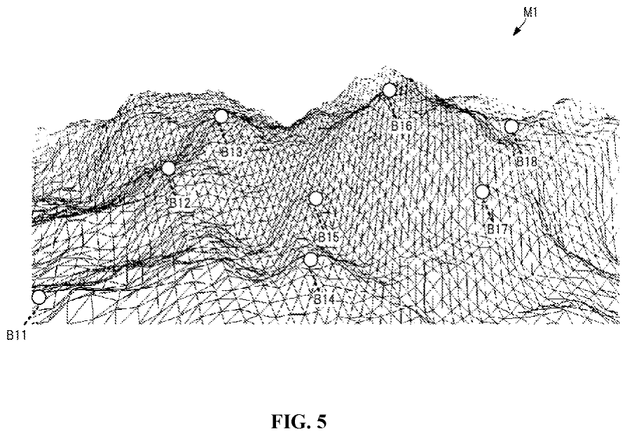

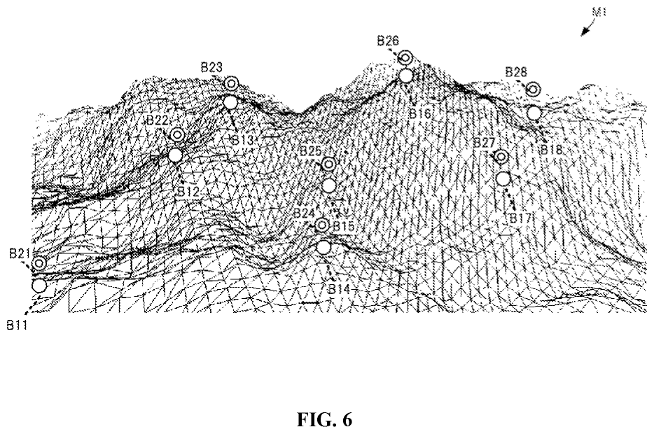

The transport network CN may include a plurality of nodes with adjusted heights (air passing-nodes B2, referring to FIG. 6 and the like) in a plurality of bases B1 (referring to FIG. 5 and the like), and also include the connection relationship connecting the plurality of air passing-nodes B2. The connection relationship may be shown by a transportable path P1 (referring to FIG. 7 and the like) capable of transporting a cargo C1 (referring to FIG. 15). The bases B1 may be called nodes, and the transportable path P1 may also be called a sideline.

In one embodiment, it may be assumed that a transport network for transporting the cargo C1, where the terrain of the transport region may be complicated and the transport region may be large, may mainly be used as the transport network CN. The transport network CN in a mountain region M1 (shown in FIG. 5 and the like) may be used as an example of the transport network CN. The transport network CN may be located outside the mountain region M1. For example, the transport network CN may also be used to transport the cargo C1 in a city region with high-rise buildings, that is, buildings with different heights. The cargo C1 may be transported by effectively bypassing the positions of buildings with different heights. In one embodiment, the mountain region M1 may mainly be an example for the transport region.

The PC control element 91 may acquire the three-dimensional terrain information indicating the transport region of the cargo C1 to be transported. The PC control element 91 may acquire the information of the mountain region M1 used as the transport region, and also the three-dimensional terrain information of the mountain region M1. The PC control element 91 may acquire the information (e.g., a mountain name and the selection information of a mountain region on a displayed map) of the mountain region M1 used as the transport region based on the user input through the operation element 93. Therefore, the mountain region M1 of the transport region may be specified according to the intention of the user who generates the transport network CN.

The three-dimensional terrain information may be, for example, the information of the latitude, longitude and height of each position of the mountain region M1 used as the transport region. Based on the information of the latitude, longitude and height, the terrain information such as the mountain undulation, the slope of the mountain, and the like may be obtained. The PC control element 91 may acquire the three-dimensional terrain information of the mountain region M1 by referring to the three-dimensional map database stored in the memory 97. In such case, the three-dimensional terrain information may be stored in the memory 97 in advance. The PC control element 91 may acquire the three-dimensional terrain information of the mountain region M1 by referring to the three-dimensional map database managed by the server on the network through the wireless communication element 95.

The PC control element 91 may acquire the three-dimensional position information of the plurality of bases B1 in the mountain region M1 used as the transport region. The bases B1 may be on the ground (the mountain surface), and may be sites of a transport source, a transport destination, a transit station, a final transport destination of the cargo C1. The bases B1 may be any houses, cargo collection stations, mountain huts, and the like. The information of the bases B1 may be used to manage the transport bases for transporting the cargo C1 through, for example, the transport server 40 owned by a transporter.

For example, the PC control element 91 may transmit the information of the mountain region M1 to the transport server 40 through the wireless communication element 95 when passing the mountain region M1 which is specified as the transport region by the operation element 93 and the like. In the transport server 40, the sever control element may acquire the information of the mountain region M1 and the information (e.g., the three-dimensional position information) of the plurality of bases B1 contained in the mountain region M1 which may be stored in the memory and the storage device through the wireless communication element, and may also transmit the information of the plurality of bases B1 to the PC 90 through the wireless communication element.

The base B1 may be a location for the cargo C1 aggregation when transporting the cargoes C1. The base B1 may be a location for the cargo C1 transit when transporting the cargoes C1. The base B1 may also be a location for the final transport destination of the cargoes C1 when the cargoes C1 are transported. When transiting the cargoes C1, once one unmanned aerial vehicle 100 lands on the ground and the cargoes C1 are unloaded, other unmanned aerial vehicles 100 may re-aggregate the cargoes C1. As a result, the PC 90 may construct the transport network CN which restrains the problem that the cargoes C1 may not be transported over a long distance due to insufficient battery of the unmanned aerial vehicles 100.

The PC control element 91 may generate air passing-nodes B2 over the bases B1. In such case, the PC control element 91 may change the height information and calculate the positions of the air passing-nodes B2 according to the positions of the bases B1. The air passing-nodes B2 may be nodes in the air of the transport region such as the mountain region M1 and the like and may also be nodes where the unmanned aerial vehicle 100 passes during the cargo transport. That is, the unmanned aerial vehicle 100 may pass the air passing-nodes B2 during takeoffs and landings. The air passing-nodes B2 may be directly above the bases B1 and be at the positions where the heights of the bases B1 are changed. That is, the position information of the air passing-nodes B2 may be represented by the same latitude information and longitude information as the bases B1 and the height information that the heights from the bases B1 are changed. The PC control element 91 may calculate the three-dimensional information of the air passing-nodes B2 based on the location information of the bases B1. The air passing-nodes B2 may also be called vertexes, and the like.

The PC control element 91 may calculate the three-dimensional positions of the air passing-nodes B2 located above the bases B1 by adding a predetermined height (e.g., 50 m) to the heights of the bases B1. The distances (i.e., height differences) between the bases B1 and the air passing-nodes B2 located above the bases B1 may be same or different for each base B1 in the mountain region M1.

The PC control element 91 may connect the plurality of the bases B1 through an arbitrary combination to generate the information of the three-dimensional connection relationship. For example, the PC control element 91 may connect the plurality of air passing-nodes B2 through the arbitrary combination to generate a transportable path P1 capable of transporting the cargo C1. The transportable path P1 may be an example of the three-dimensional connection relationship. The transportable path P1 connecting any two of the air passing-nodes B2 may be connected by a straight line, that is, the cargo C1 may travel along the straight line.

The information of the transportable path P1 may include the identification and position information of the two of the air passing-nodes B2 connected by the transportable path P1, the three-dimensional position information during the travel in transportable path P1, and the like. The PC control element 91 may calculate the three-dimensional position information during the travel in the transportable path P1 according to the different between the position information of the two of the air passing-nodes B2 connected by the transportable path P1.

The PC control element 91 may generate the transportable paths P1 according to various methods. For example, the PC control element 91 may generate the plurality of transportable paths P1 connecting the plurality of air passing-nodes B2 according to a three-dimensional triangulation method. In the transport network CN generated by the three-dimensional triangulation method, each of the plurality of transportable paths P1 may not conflict with each other. The length of the transportable path P1 in the mountain region M1 may be, for example, 1 km or more.

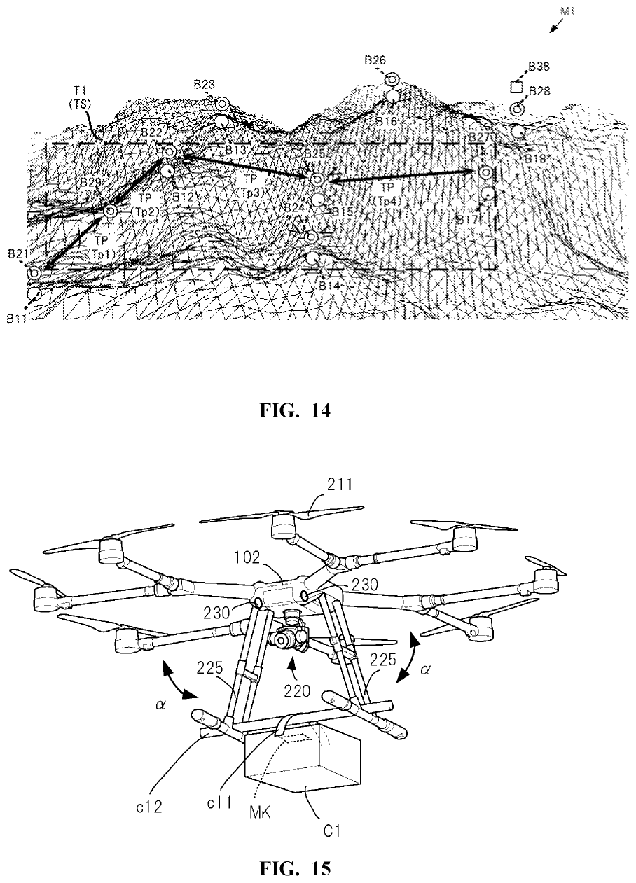

The PC 90 may generate the plurality of transportable paths P1 connecting the plurality of air passing-nodes B2 according to the three-dimensional triangulation method, which may restrain the generation of a transportable path P1 connecting two air passing-nodes B2 with relatively low transport efficiency, and may generate a transportable path P1 connecting two air passing-nodes B2 with relatively high transport efficiency. As a result, the PC 90 may generate the plurality of transportable paths P1 which may be the basis of transport paths T1 (refer to FIG. 14) for efficiently transporting the cargo C1 when the actual cargo C1 is transported, thereby constructing the transport network CN.

The PC control element 91 may generate the transport network CN according to the plurality of air passing-nodes B2 and the plurality of transportable paths P1 connecting the plurality of air passing-nodes B2. The transport network CN may be formed by the plurality of air passing-nodes B2 and the plurality of transportable paths P1 connecting the plurality of air passing-nodes B2. The transport network CN may also be formed by the plurality of air passing-nodes B2, the plurality of transportable paths P1 connecting the plurality of air passing-nodes B2, and the plurality of bases B1 corresponding to the plurality of air passing-nodes B2. The information of the transport network CN may include the identification information and the position information of the plurality of air passing-nodes B2, the identification information of the plurality of transportable paths P1, and the position information during the travel in the plurality of transportable paths P1. The information of the transport network CN may also include the identification information and the position information of the plurality of bases B1.

When a length of a transportable path P1 is longer than the longest transport distance of the unmanned aerial vehicle 100, the PC control element 91 may also exclude the transportable path P1 longer than the longest transport distance from the transport network CN. That is, the PC control element 91 may delete a sideline longer than a predetermined distance (e.g., the longest transport distance). As a result, the unmanned aerial vehicle 100 may transport the cargo C1 within a capable transport range of the unmanned aerial vehicle 100, and may restrain, for example, the problem that the cargo C1 may not be transported in the middle of the transport path due to insufficient battery.

The longest transport distance of the unmanned aerial vehicle 100 may be the longest distance that the unmanned aerial vehicle 100 may transport the cargo C1. The longest transport distance may also be consistent with the longest flight distance of the unmanned aerial vehicle 100. The longest transport distance may also be a distance, which is determined according to the payload (e.g., weight) of the cargo C1 loaded by the unmanned aerial vehicle 100. The longest transport distance may also be, for example, a distance, which is determined using added normal wind directions and added wind intensities in the mountain region M1. The longest transport distance may also be, for example, a distance, which is determined using an added maximum charging level of a battery included in the unmanned aerial vehicle 100 and an added battery usage efficiency during the flight of the unmanned aerial vehicle 100. The PC control element 91 may also acquire the information of the longest transport distance of the unmanned aerial vehicle 100 from the unmanned aerial vehicle 100 through, for example, the wireless communication element 95. The longest transport distance may also be a predetermined distance (e.g., 5 km), which is a threshold value of the transport distance that the unmanned aerial vehicle 100 may fly continuously.

The PC control element 91 may determine whether the transportable path P1 is in contact with the ground (the surface of the mountain) at any location in the mountain region M1 by referring to the acquired three-dimensional terrain information in the mountain region M1. The contact between the transportable path P1 and the ground may be determined by, for example, whether a line of the transportable path P1 in the three-dimensional coordinates representing the three-dimensional space is in contact with a surface of the slope of the mountain region M1. In the case that the transportable path P1 extending in the three-dimensional space is in contact with the ground, the unmanned aerial vehicle 100, which flies according to the transportable path P1, may come into contact with the ground to be damaged. In such case, the PC control element 91 may perform modification to change the travel state of the transportable path P1.

The PC 90 may change the travel state of the transportable path P1 by performing the modification, thereby restraining the contact between the transportable path P1 and the ground. As a result, the PC 90 may construct the following transport network CN capable of restraining the damage of the unmanned aerial vehicle 100 or the damage or dropping of the cargo C1 to be transported because the unmanned aerial vehicle 100 flies along the transportable path P1 in contact with the ground.

When the distance between two adjacent air passing-nodes B2 in the transport network CN is greater than or equal to the longest transport distance, the PC control element 91 may add an air passing-node B2, used as a transit node, between the air passing-nodes B2. The position of the air passing-node B2 used as the transit node may be on a straight line connecting the above-mentioned two air passing-nodes and may also be a position deviating from the straight line. In addition, a plurality of transit nodes may also be arranged between two adjacent air passing-nodes B2. The determined position of the transit node may be, for example, a site in the forest in the mountain region M1. In such case, a new site in the forest may be developed, and a new base corresponding to the air passing-node B2 may be constructed. For example, the site suitable for the aggregation and unloading of the cargo C1 may be newly added as the base B1.

FIG. 5 illustrates a diagram of an arrangement example of the bases B1 (B11-B18) in the mountain region M1 according to some embodiments of the present disclosure. In the mountain region M1, the plurality of bases B11-B18 may be arranged in various three-dimensional positions.

FIG. 6 illustrates a diagram of an arrangement example of the bases B1 (B11-B18) and the air passing-nodes B2 (B21-B28) in the mountain region M1 according to some embodiments of the present disclosure. The bases B11-B18 and the air passing-nodes B21-B28 may be disposed accordingly. The heights of the bases B11-B18 may be changed, thereby using as the air passing-nodes B21-B28.

FIG. 7 illustrates a diagram of an example of the transport network in the mountain region M1. The transport network CN may include vertices of the plurality of air passing-nodes B21-B28 and sidelines of the plurality of transportable paths P1. In FIG. 7, the transportable path P1 may have the sidelines connecting the passing-nodes B21 and B22, B21 and B24, B22 and B23, B22 and B24, B23 and B25, B23 and B26, B24 and B25, B24 and B27, B25 and B26, B25 and B27, B25 and B28, B26 and B27, B26 and B28, and B17 and B28, respectively.

That is, the PC control element 91 may generate the sideline by connecting two vertices of the air passing-nodes B2 according to the three-dimensional triangulation method, and the like. In the transport network CN generated according to the three-dimensional triangulation method, each of the plurality of sidelines may not conflict. In addition, the plurality of sidelines may not conflict and intersect in the three-dimensional space. However, in the two-dimensional view shown in FIG. 7, sidelines (the transportable path P1), including the sideline connecting the air passing-nodes B26 and B27, and the sideline connecting the air passing-nodes B25 and B28, may intersect each other.

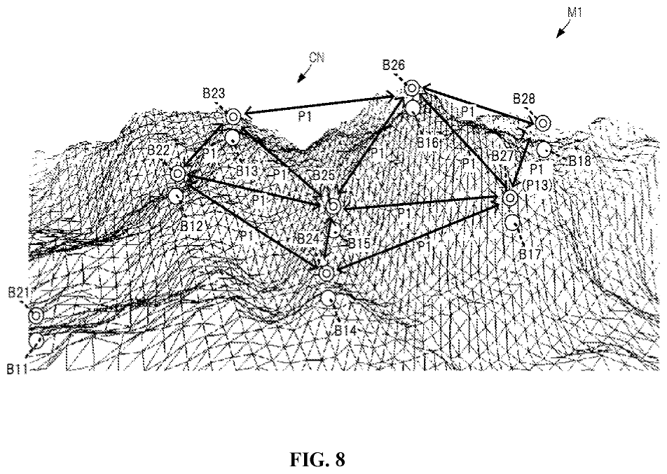

FIG. 8 illustrates a diagram of the transport network CN with deleted sidelines in the mountain region M1 according to some embodiments of the present disclosure. As shown in FIG. 8, the sidelines which have lengths longer than the longest transport distance of the unmanned aerial vehicle 100 may be deleted in the transportable path P1. For example, a transportable path P11a (referring to FIG. 7) connecting the air passing-nodes B21 and B22, a transportable path P11b (referring to FIG. 7) connecting the air passing-nodes B21 and B24, and a transportable path P12 (referring to FIG. 7) connecting the air passing-nodes B25 and B28 may be deleted. As a result, the distance between the air passing-node B21 and any other air passing-nodes B2 (B22-B28) may be longer than the longest transport distance. That is, the air passing-node B21 may be isolated and independent of other air passing-nodes B2. The independent air passing-node B21 may be referred to as an independent node. The transportable paths P11a, P11b, and P 12 may be examples of a second transportable path.

The PC 90 may delete the sidelines such that the distances between the air passing-nodes B2 connected by the transportable path P1 may all within the transportable distance. Therefore, The PC 90 may construct the following transport network CN in the middle of the transportable path P1, that is, between any two air passing-nodes B2, where the transport network CN may restrain the problem that the cargo C1 may not be transported due to insufficient battery of the unmanned aerial vehicles 100.

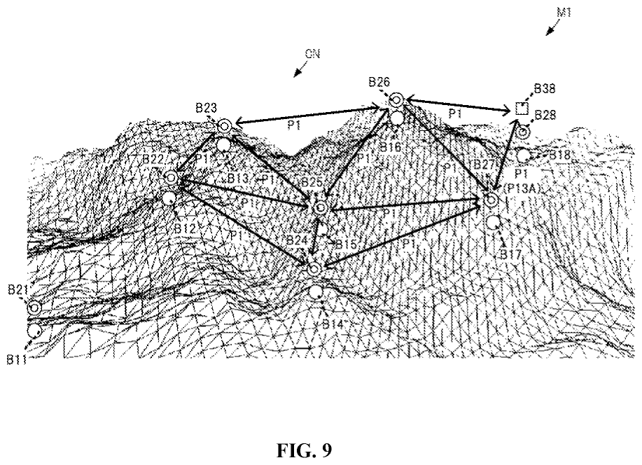

FIG. 9 illustrates a diagram of the transport network CN of a ground conflict with sidelines in a mountain region M1 according to some embodiments of the present disclosure. In an example shown in FIG. 9, the height of the air passing-node B28 may be adjusted to set a new air passing-node B38 located above the air passing-node B28. The air passing-node B38 may be set, for example, when the transportable path P13 (referring to FIG. 7) connecting the air passing-node B27 and the air passing-node B28 is in contact with the ground. The transportable path P13 may be an example of a first transportable path.

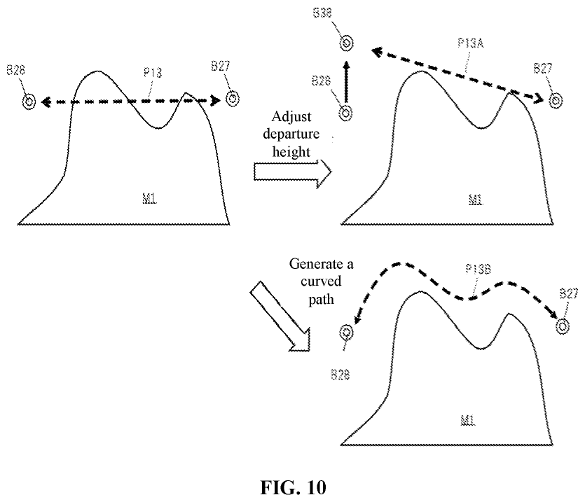

FIG. 10 illustrates a diagram of a modified transportable path P1 of a ground conflict with sidelines in a mountain region M1 according to some embodiments of the present disclosure. The PC control element 91 may modify the transportable path P1 by increasing the heights of any of the air passing-nodes B27 and B28 in the air passing-nodes B27 and B28 which are two end nodes connected by the transportable path P1. That is, the PC control element 91 may implement height modification of the air passing-nodes B27 or B28 at a departure site, or height modification of the air passing-nodes B28 or B27 at a destination site. In FIG. 10, the height of the air passing-node B28 is changed to obtain the air passing-node B38, thereby generating a transportable path P13A connecting the air passing-nodes B38 and B27 by a straight line. Furthermore, the height of the air passing-node B38 may be any height as long as the transportable path P13A does not conflict with the ground.

In such way, the PC 90 may modify the transportable path P13 by increasing the height of any of the air passing-nodes B27 and B28 in the air passing-nodes B27 and B28 which are two end nodes being connected by the transportable path P13 in contact with the ground, thereby generating the transportable path P13A. As a result, the PC 90 may restrain the contact between the transportable path P13A and the ground. In such case, the PC 90 may only need to modify the height of at least one air passing-node B28 in the transportable path P13 with the plurality of air passing-nodes B27 and B28. Therefore, the PC 90 may conveniently implement the modification process, which is configured to restrain the ground conflict of the transportable path P13 in the transport network CN.

Furthermore, as shown in FIG. 10, the PC control element 91 may change the shape of the transportable path P13 with the ground conflict by conformally matching the shape of the terrain in the mountain region M1, thereby modifying the transportable path P13. The PC control element 91 may generate a curved shape of a newly generated transportable path P13B conformally along the ground shape at the same latitude and longitude positions of the transportable path P13 according to the three-dimensional terrain information in the mountain region M1. For example, the PC control element 91 may maintain a constant height (e.g., 50 m) from the ground in each air position of the transportable path P13B and generate the curved transportable path P13B.

Accordingly, the PC 90 may change the shape of the transportable path P13 in contact with the ground in the air by conformally matching with the ground shape where the transportable path P13 is located, thereby generating the transportable path P13B. As a result, the PC 90 may avoid the contact between the transportable path P13B and the ground. Furthermore, when comparing the transportable path P13A with the transportable path P13B, even if the height of the transportable path P13B is reduced compared to the height of the transportable path P13A of the air passing-nodes B38 and B27, the transportable path P13B may not be in contact with the ground. For example, the PC 90 may construct the following transport network CN which may restrain the lower operation efficiency problem of the unmanned aerial vehicle 100 because the higher height the unmanned aerial vehicle 100 flies, the easier the unmanned aerial vehicle 100 is affected by the wind in the air.

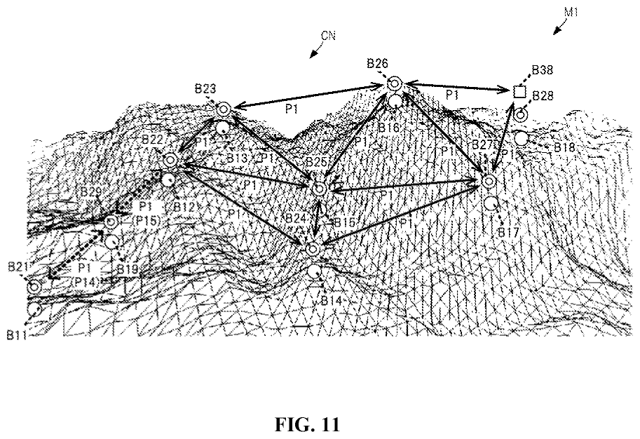

FIG. 11 illustrates a diagram of the transport network CN with an added transit node in the mountain region M1 according to some embodiments of the present disclosure. In FIG. 11, an air passing-node B29 as a transit node may be added between the air passing-node B21 (an example of a first air passing-node) and the air passing-node B22 (an example of a second air passing-node). A base B19 may be added below the air passing-node B29. With the addition of the air passing-node B29, the PC control element 91 may generate the transport network CN with an added transportable path P1 (P14) connecting the air passing-node B21 and the air passing-node B29, and an added transportable path P1 (P15) connecting the air passing-node B29 and the air passing-node B22.

The PC 90 may, by adding the air passing-node B29 as the transit node in the transport network CN, connect each air passing-node B2 at a distance less than the longest transportable distance of the unmanned aerial vehicle 100 between the air passing-node B21 and the air passing-node B22. Therefore, the PC 90 may construct the following transport network CN between each air passing-node B2, which may restrain the problem that the cargoes C1 may not be transported over a long distance due to insufficient battery of the unmanned aerial vehicles 100.

Next, the operation of the PC 90 when generating the transport network CN may be described hereinafter.

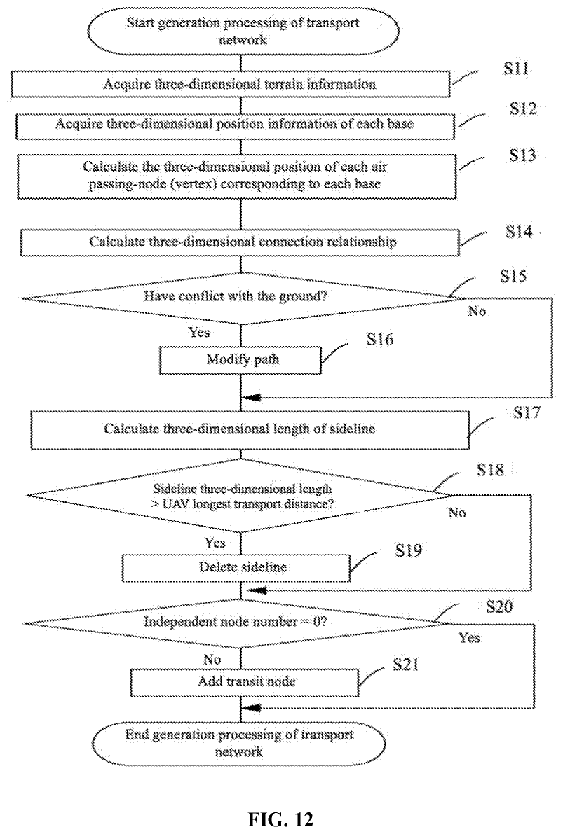

FIG. 12 illustrates a flow chart of the operation of the PC 90 when generating the transport network according to some embodiments of the present disclosure.

First, the PC control element 91 may acquire the three-dimensional terrain information of the mountain region M1 used as the transport region (S11). The PC control element 91 may, for example, acquire the three-dimensional position information of each base B1 in the mountain region M1 in cooperation with the transport server 40 (S12).

The PC control element 91 may calculate the three-dimensional position of each air passing-node B2 (vertex) corresponding to each base b1 (S13). The PC control element 91 may, for example, connect any air passing-node B2 in the plurality of air passing-nodes B2 according to the three-dimensional triangulation method, and also calculate the three-dimensional connection relationship (S14). The three-dimensional connection relationship may be represented, for example, by the transportable path P1 connecting the plurality of air passing-nodes B2. Therefore, the PC control unit 91 may generate the transportation network CN including the plurality of air passing-nodes B2 and the plurality of transportable paths P1.

The PC control element 91 may determine whether any transport path P1 in the transport network CN has a conflict with the ground (the mountain surface) in the mountain region M1 (S15). When the transport path P1 has the conflict with the mountain surface, the PC control element 91 may modify the transportable path P1 to be not in contact with the mountain surface (S16).

The PC control element 91 may calculate the length of the transportable path P1 (sideline) included in the transport network CN (S17). For example, the lengths of all transportable paths P1 included in the transport network CN may be calculated. The length of the transportable path P1 may be calculated by the position information difference between two air passing-nodes B2 connected by the transportable path P1. That is, the length of the transportable path P1 may be a three-dimensional distance between two air passing-nodes B2 connected by the transportable path P1.

The PC control element 91 may determine whether the length of the transportable path P1 included in the transport network CN is greater than the longest transport distance of the unmanned aerial vehicle 100 (S18). When the length of the transportable path P1 is greater than the longest transport distance of the unmanned aerial vehicle 100, the PC control element 91 may delete the transportable path P1, which has the length greater than the longest transport distance of the unmanned aerial vehicle 100, from the transport network CN (S19).

The process of the S18 may be determining whether the length of each transportable path P1 is greater than the longest transport distance of the unmanned aerial vehicle 100. Therefore, each transportable path P1, which has the length greater than the longest transport distance of the unmanned aerial vehicle 100, may be deleted from the transport network CN.

The PC control element 91 may determine whether the number of the independent nodes included in the transport network CN is 0 (S20). When the number of the independent nodes is 0, the PC control element 91 may end the processing shown in FIG. 12. When the number of the independent nodes is not 0, the PC control element 91 may additionally arrange the air passing-node B2 as the transit node in the transport network CN (S21). After the step S21, the PC control element 91 may end the processing shown in FIG. 12.

When the number of the independent nodes is not 0, that is, when the independent nodes exist, it may indicate that the transportable path P1 which has the length greater than the longest transport distance of the unmanned aerial vehicle 100 may exist in the transport network CN. In such case, the unmanned aerial vehicle 100 may also avoid the problem that the cargo may not be transported due to insufficient battery in the middle of any transportable path P1 in the transport network CN by using the newly added air passing-node B2.

Furthermore, when the number of the independent nodes is 0, that is, when the independent nodes do not exist, it may indicate that the transportable path P1 which has the length greater than the longest transport distance of the unmanned aerial vehicle 100 may not exist in the transport network CN. In such case, the unmanned aerial vehicle 100 may fly along the transportable path P1 existing in the transport network CN generated before the S19 processing. That is, even if the air passing-node B2 as the transit node is not newly added in the transport network CN, the problem that the cargo may not be transported due to insufficient battery in the middle of any transportable path p1 in the transport network CN may also be avoided.

According to the process in FIG. 12, the PC 90 may add the position of the base B1 capable of aggregating and unloading the cargo C1, thereby generating the transportable paths P1 connecting the plurality of air passing-nodes B2, and also constructing the transport network CN including the plurality of air passing-nodes B2 and the plurality of transportable paths P1. For example, the PC control element 91 may acquire the three-dimensional position information of each base B1 and calculate the air passing-node B2. The PC control element 91 may calculate the three-dimensional position relationship of each air passing-node B2 according to the triangulation method, that is, the PC control element 91 may acquire the three-dimensional connection relationship. The PC control element 91 may also optimize each sideline (e.g., the sideline deletion and the transit node addition) according to the flight limit (e.g., the longest transport distance) and the three-dimensional terrain (e.g., the three-dimensional terrain information in the transport region) of the unmanned aerial vehicle 100.

Furthermore, even if the terrain of the transport region including the mountain region M1 for transporting the cargo C1 is complicated, and the transport region is large relative to the longest transport distance of the unmanned aerial vehicle 100, the PC 90 may still construct the transport network CN capable of transporting the cargo C1 through the unmanned aerial vehicle 100. Therefore, the PC 90 may construct the transport network CN capable of reducing the cost required for the cargo C1 transport such as labor costs, and the like. In addition, the PC 90 may construct the transport network CN capable of transporting the cargo C1 through the unmanned aerial vehicle 100, not a transport network CN for transporting the cargo C1 through the personnel and vehicles on the ground. Furthermore, the unmanned aerial vehicle 100 may move freely in the three-dimensional space, thus the PC 90 may construct the transport network CN with excellent utilization efficiency in the three-dimensional space. In addition, the unmanned aerial vehicle 100 may easily implement stationary and large-angle maneuvers. Therefore, compared with the transport network for transporting the cargo by a helicopter, the PC 90 may construct a small-turn and flexible transport network CN.

In such way, the PC 90 may be configured to support the automation and unmanned transport of the cargo C1 (e.g., mountain region cargo transport) implemented by the unmanned aerial vehicle 100 in a complicated and large terrain.

Cargo Transport Through the Transport Network

Next, the transport of the cargo C1 through the transport network CN may be exemplarily described.

The functions related to the transport of the cargo C1, included in the UAV control element 110 of the unmanned aerial vehicle 100, may be first described. The UAV control element 100 may be an example of a processing element. The UAV control element 100 may perform the processing related to the transport of the cargo C1. In addition, a processing for supporting the transport of the cargo C1 performed by a device other than the unmanned aerial vehicle 100 may also be described.

The UAC control element 110 may acquire the information (e.g., position information) of the base B1 of the transport source of the cargo C1 in the mountain region M1 used as the transport region. The UAV control element 110 may acquire the current position information of the unmanned aerial vehicle 100, that is, the aircraft itself, which may be used as the information of the base B1 as the transport source. The current position information of the unmanned aerial vehicle 100 may be acquired through, for example, the GPS receiver 240. In addition, the unmanned aerial vehicle 100 may be in any base B1 in the transport region before transporting the cargo C1. In such case, the information of the base B1 of the transport source may be acquired from the transport server 40 through, for example, the communication interface 150, and may be used as the position information of the base B1 where the unmanned aerial vehicle 100 is located.

Furthermore, the information of the base B1 of the transport source may be acquired from the transport server 40 through, for example, the communication interface 150.

For example, in the mobile terminal 80, the operation element 83 may receive the identification information of the base B1 of the transport source for identifying the base B1 of the transport source from the transport client, and the wireless communication element 85 may transmit the identification information of the base B1 of the transport source to the transport server 40. In the transport server 40, the wireless communication element may receive the identification information of the base B1 of the transport source from the mobile terminal 80; the server control element may read the position information of the base B1 of the transport source corresponding to the identification information of the base B1 of the transport source; and the wireless communication element may transmit the position information of the base B1 of the transport source to the unmanned aerial vehicle 100. In addition, the transport source of the cargo C1 may exist outside of the mountain region M1 or may exist inside the mountain region M1. When the transport source of the cargo C1 exists outside of the mountain region M1, the first transit node in the mountain region M1 when the transported cargo C1 is passed may be used as the base B1 of the transport source in the mountain region M1. For example, the base B1 in the mountain region M1 with the shortest distance from the transport source of the cargo C1 may be used as the base B1 of the transport source in the mountain region M1.

The UAV control element 110 may acquire the information (e.g., the position information) of the base B1 of the final transport destination in the mountain region M1 used as the transport region. The information of the base B1 of the final transport destination may be acquired from the transport server 40 through, for example, the communication interface 150.

For example, in the mobile terminal 80, the operation element 83 may receive the identification information of the base B1 of the final transport destination for identifying the base B1 of the final transport destination from the transport client, and the wireless communication element 85 may transmit the identification information of the base B1 of the final transport destination to the transport server 40. In the transport server 40, the wireless communication element may receive the identification information of the base B1 of the final transport destination from the mobile terminal 80; the server control element may read the position information of the base B1 of the final transport destination corresponding to the identification information of the base B1 of the final transport destination; and the wireless communication element may transmit the position information of the base B1 of the final transport destination to the unmanned aerial vehicle 100. In addition, the final transport destination of the cargo C1 may exist outside of the mountain region M1 or may exist inside the mountain region M1. When the final transport destination of the cargo C1 exists outside of the mountain region M1, the final transit node in the mountain region M1 when the transported cargo C1 to the final transport destination is passed may be used as the base B1 of the final transport destination in the mountain region M1. For example, the base B1 in the mountain region M1 with the shortest distance from the final transport destination of the cargo C1 may be used as the base B1 of the final transport destination in the mountain region M1.

In addition, the information of the base B1 of the final transport destination of the cargo C1 recorded in the packing slip of the cargo C1 may be described as text information. In such case, the UAV control element 110 may make the capturing element 220 or 230 to capture the packing slip of the cargo C1, and also perform text recognition on the captured image and detect the text information. The UAV control element 110 may acquire the detected text information as the information of the base B1 of the final transport destination in the mountain region M1. The packing slip of the cargo C1 may be, for example, directly attached to the cargo C1 and the like or may be attached to a box containing the cargo C1 and the like. In addition, the UAV control element 110 may detect the identification information of the base B1 from the text information, and also acquire the position information of the base B1 corresponding to the identification information of the base B1 in cooperation with the transport server 40.

Furthermore, a color cargo tag may be attached to the cargo C1. In such case, the UAV control element 110 may make the capturing element 220 or 230 to capture the cargo tag, and also perform image recognition on the captured image and detect the color information. The UAV control element 110 may acquire the information of the base B1 of the final transport destination corresponding to the color information according to the detected color information. The cargo tag may be directly attached to the cargo C1 and the like or may be attached to a box containing the cargo C1 and the like. In addition, the boxes containing the cargoes C1 may have different colors according to the final transport destinations; and the information of the base B1 of the final transport destination may be acquired according to the color information. In addition, the UAV control element 110 may detect the identification information of the base B1 from the color information, and also acquire the position information of the base B1 corresponding to the identification information of the base B1 in cooperation with the transport server 40.

The UAV control element 110 may acquire the information of the transport network CN. For example, the UAV control element 110 may receive the information of the transport network CN generated by the PC 90 through the communication interface 150. The UAV control element 110 may store the acquired information of the transport network CN into the memory 160. In addition, the UAV control element 110 may also acquire the information of the transport network CN from a device other than the PC 90 which stores the information of the transport network CN. The transport network CN may be a transport network, which has the plurality of air passing-nodes B2 and the connection relationship information of connecting the plurality of air passing-nodes B2, but the transport network CN may be generated by a method different from the PC 90 generation method.

The UAV control element 110 may generate a transport path T1 connecting the transport source and the final transport destination of the cargo C1 in the mountain region M1 according to the transport network CN. The transport path T1 may be formed by the combination of one or more transportable paths P1 included in the transport network CN. The information of the transport path T1 may include the information of the transportable paths P1 selected from the transport network CN and the information of the plurality of air passing-nodes B2 passing through the transport path T1. The transport path T1 may be a path with a smallest sum value of the combined transportable paths P1 in the transport network CN, that is, the shortest transport path in the transport network CN. The UAV control element 110 may calculate, for example, the shortest transport path TS connecting the base B1 of the transport source and the base B1 of the final transport destination of the cargo C1 according to the Dijkstra algorithm, and also generate the shortest transport path TS.

The UAV control element 110 may acquire the information of a next base B1 in the transport path T1 using the base B1 of the transport source as a basis point. That is, the next base B1 may be included in the transport path T1; the base of the transport source may be connected to a partial transport path (a partial transport path Tp) at one end of the next base B1; and the base B1 of the transport destination may be connected to a partial transport path at the other end of the next B1.

The UAV control element 110 may aggregate the cargoes C1 of a transport subject in the base B1 of the transport source. The UAV control element 110 may hold the cargoes C1 in a holding state when the cargoes C1 are aggregated. The UAV control element 110 may aggregate a single cargo C1 or may store the cargoes C1 into a box and aggregate the cargoes C1 included in the box. The UAV control element 110 may transport one single cargo or the plurality of cargoes C1 in one transport. The UAV control element 110 may transport one single box containing the cargoes C1 or transport the plurality of boxes containing the cargoes C1 in one transport.

The UAV control element 110 may hold the aggregated cargoes C1 when the cargoes C1 are aggregated, and also enable the unmanned aerial vehicle 100 to take off and fly upwardly from the base B1 of the transport source and reach the air passing-node B2 of the transport source. The UAV control element 110 may hold and transport the aggregated cargoes C1 to the air passing-node B2 of the transport destination corresponding to an acquired next base B1 according to the generated transport path T1. That is, during the transport of the cargoes C1, the UAV control element 110 may perform the flight control on the transport destination base B1 when holding the cargoes C1. The UAV control element may enable the unmanned aerial vehicle 100 to fly downwardly when reaching the air passing-node B2 of the transport destination and land on the base B1 of the transport destination.

The UAV control element 110 may remove the holding state of the cargoes C1 at the base B1 of the transport destination, thus the cargoes C1 may be unloaded from the unmanned aerial vehicle 100. When the base B1 of the transport destination is the final transport destination, the cargoes C1 may be received by the consignee of the cargoes C1. When the base B1 of the transport destination is not the final transport destination, the base B1 of the transport destination may be the transit site.

For example, the cargoes C1 may be aggregated and also transported to the next base B1 by another unmanned aerial vehicle 100 which is responsible for the transport of a next partial transport path Tp in the transport path T1. Therefore, even when the distance between the bases B1 is a long distance, the unmanned aerial vehicle 100 may restrain the problem that the cargoes C1 may not be transported to the next base B1 due to insufficient electric power.

The UAV control element 110 may perform the flight control on the base B1 of the transport source after the cargoes C1 are unloaded by removing the holding state or the like. That is, the UAV control element 110 may enable the unmanned aerial vehicle 100 to be returned. In addition, when the unmanned aerial vehicle 100 returns, if the base B1 of the transport destination (the base where the unmanned aerial vehicle 100 is currently located) may has the cargoes C1 which should be transported to the base B1 of the transport source (the base of the return destination), the UAV control element 110 may aggregate the cargoes C1, and also hold and return the cargoes C1.

The unmanned aerial vehicle 100 may restrain the reduction of the number of the unmanned aerial vehicles 100 arranged in the base B1 of the transport source when the cargoes C1 are transported each time by returning the unmanned aerial vehicles 100 to the base B1 of the transport source. Therefore, even the cargoes C1 are required to be transported from the base B1 of the transport source regularly, it is also possible to restrain the shortage of the unmanned aerial vehicles 100 at the base B1 of the transport source, thereby quickly transporting the cargoes C1.

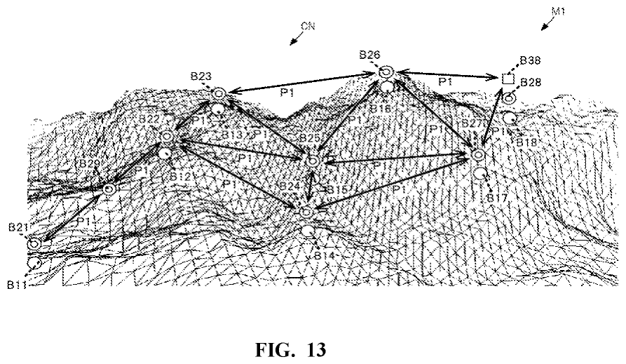

FIG. 13 illustrates a diagram of the transport network CN acquired by the unmanned aerial vehicle 100 according to some embodiments of the present disclosure. As an example, the transport network CN shown in FIG. 13 may be the same as the transport network CN shown in FIG. 11. That is, the transport network CN acquired by the unmanned aerial vehicle 100 may be the same as the transport network CN generated by the PC 90. In addition, the UAV control element 110 may acquire the information of the transport network CN different from the transport network CN generated by the PC 90, and also may use the transport network CN for transporting the cargoes C1. Even in such case, the transport network acquired by the unmanned aerial vehicle 100 may also be the transport network which includes the air passing-nodes corresponding to the plurality of predetermined bases and the transportable paths arbitrarily connecting the plurality of bases.

FIG. 14 illustrates a diagram of the transport path T1 according to some embodiments of the present disclosure. As an example of the transport path T1, the shortest transport path TS is shown in FIG. 14. In FIG. 14, as an example, it is assumed that the base B1 of the transport source is the base B11, and the base B1 of the final transport destination is the base B17. The air passing-node B21 may be arranged corresponding to the base B11, and the air passing-node B27 may be arranged corresponding to the base B17. In FIG. 14, the shortest transport path TS may include four partial transport paths Tp. For example, the shortest transport path TS may include a partial transport path Tp1 connecting the air passing-node B21 and the air passing-node B29, a partial transport path Tp2 connecting the air passing-node B29 and the air passing-node B22, a partial transport path Tp3 connecting the air passing-node B22 and the air passing-node B25, and a partial transport path Tp4 connecting the air passing-node B25 and the air passing-node B27. That is, the shortest transport path TS may be a path which connects each air passing-node B21, B29, B22, B25, and B27 passing through by the unmanned aerial vehicle 100 at the shortest distance.

The unmanned aerial vehicle 100 may transport the cargoes C1 according to the shortest transport path TS, thereby reducing the battery usage during the transport of the cargoes C1 to save energy. In addition, the shortest transport path TS may be shorter in length than other transport paths T1. Therefore, the transport time required for transporting the cargoes C1 from the transport source to the final transport destination by the unmanned aerial vehicle 100 may be shortened.

In addition, the plurality of unmanned aerial vehicles 100 may be arranged according to the size (the range size) of the mountain region M1 used as the transport region. The arranged unmanned aerial vehicle 100 may be assigned to each base B1 on standby until being used in the transport of the cargoes C1 and the like. Each of the plurality of unmanned aerial vehicles 100 may at least transport the cargoes C1 from each base B1 of the transport source to the base B1 of an adjacent transport destination.

For example, in FIG. 14, a first unmanned aerial vehicle 100 may hold the cargoes C1 in the base B11, ascend from the base B11, transport the cargoes C1 from the air passing-node B21 to the air passing-node B29, descend from the air passing-node B29, and unload the cargoes C1 in the base B19; a second unmanned aerial vehicle 100 may hold the cargoes C1 in the base B19, ascend from the base B19, transport the cargoes C1 from the air passing-node B29 to the air passing-node B22, descend from the air passing-node B22, and unload the cargoes C1 in the base B12; a third unmanned aerial vehicle 100 may hold the cargoes C1 in the base B12, ascend from the base B12, transport the cargoes C1 from the air passing-node B22 to the air passing-node B25, descend from the air passing-node B25, and unload the cargoes C1 in the base B15; and a fourth unmanned aerial vehicle 100 may hold the cargoes C1 in the base B15, ascend from the base B15, transport the cargoes C1 from the air passing-node B25 to the air passing-node B27, descend from the air passing-node B27, and unload the cargoes C1 in the base B17.

In such way, the flight system 10 may relay the transport of the cargoes C1 from the base B1 of the transport source to the base B1 of the transport destination through the plurality of unmanned aerial vehicles 100, and may transit the cargoes C1 to finally transport the cargoes C1 from the transport source to the final transport destination. Therefore, even if the transport region is a large region (e.g., the mountain region M1), the cargoes C1 may be transited by the plurality of unmanned aerial vehicles 100 cooperatively and be transported to the final transport destination.

In addition, when partial transport paths Tp1-Tp4 are sufficiently short, relative to the longest transport distance and the shortest transport distance of the unmanned aerial vehicle 100, the unmanned aerial vehicle 100 may not only transport the cargoes C1 to an adjacent base, that is, a next base B1, but may transport the cargoes C1 to the base after the next base B1. For example, in FIG. 14, the cargoes C1 may be transported from the air passing-node B21 to the air passing-node B22 by one unmanned aerial vehicle, the cargoes C1 may also be transported from the air passing-node B21 to the air passing-node B25 by one unmanned aerial vehicle, and the cargoes C1 may further be transported from the air passing-node B21 to the air passing-node B27 by one unmanned aerial vehicle. Therefore, the number of unmanned aerial vehicles 100 to be arranged at each base B1 may be reduced.

Next, the holding form of the cargo C1 during the cargo transport is described.

FIG. 15 illustrates a schematic of the holding form of the cargo C1 according to some embodiments of the present disclosure.

In order to be easily held by the unmanned aerial vehicle 100 when the cargo is aggregated, holding auxiliary parts may be installed on the cargo C1 or the box containing the cargo C1. The holding auxiliary parts may include an auxiliary belt c11, hooks, auxiliary rods c12, and the like for holding the cargo C1 or the box in place.

The UAV control element 110 may include a cargo holding unit for holding the cargo C1 or the box in place. The cargo holding unit may include arm portions 225 of the unmanned aerial vehicle 100, convex portions and concave portions disposed on the unmanned aerial vehicle 100. The cargo holding unit may include engaging portions for engaging (e.g., fitting) with the hooks, the convex portions, the concave portions, and the like. The convex portions and the concave portions may be formed on the arm portions 225 or may be disposed separately from the arm portions 225.

In addition, the auxiliary rods c12 may be mounted on the arm portions 225 and other portions of the unmanned aerial vehicle 100 when the cargo is aggregated. The unmanned aerial vehicle 100 may also include the auxiliary rods c12 as the cargo holding unit. In such case, the auxiliary rods c12 may be folded when the cargo C1 is not held, and also may be unfolded and arranged on the arm portions 225 on two sides when the cargo C1 is held. When transporting the cargo C1, the cargo C1 may be hung on the auxiliary rods c12 through the auxiliary belt c11, and the auxiliary rods may be difficult to fall from the arm portions 225 by engaging with any part of the arm portions 225. The auxiliary rods c12 may be disposed on the side of the unmanned aerial vehicle 100, and also be disposed on the side of the cargo C1 or the box.

The UAV control element 110 may hold the cargo C1 in place by holding the holding auxiliary parts using the cargo holding unit. The UAV control element may also operate the cargo holding unit when the cargo C1 is aggregated and unloaded. In such case, the UAV control element 110 may set the cargo holding unit to be the holding state when the cargo is aggregated and may remove the holding state of the cargo holding unit when the cargo is unloaded.

For example, as shown in FIG. 15, the UAV control element 110 may move the arm portions 225 in the direction of the arrow a to sandwich the cargo C1 or the box from outer sides, and also raise and hold the cargo C1 or the box to the holding state. On the other hand, the UAV control element 110 may move the arm portions 225 in the direction of the arrow a to remove the state that the cargo C1 or the box is sandwiched from outer sides, and also unload the cargo C1 or the box and remove the holding state.

For example, the UAV control element 110 may move the arm potion 225 to fix the hooks, as the holding auxiliary parts, to the convex portions or the like of the arm portions 225, thereby holding the cargo C1 or the box to be at the holding state. On the other hand, the UAV control element 110 may move the arm potion 225 to remove the hooks, as the holding auxiliary parts, from the convex portions or the like of the arm portions 225, thereby unloading the cargo C1 or the box to remove the holding state.

By holding the cargo C1 with the cargo holding unit, the UAV control element 110 may restrain operations for holding the cargo C1 by the unmanned aerial vehicle 100 such as bundling the cargo C1 to the unmanned aerial vehicle 100 or placing the cargo C1 into the transport box held by the unmanned aerial vehicle 100 and the like by the transport client. Therefore, the time for the transport client to aggregate the cargo may be reduced, and the convenience may be further improved. In addition, the UAV control element 110 may remove the holding state of the cargo C1 by operating the cargo holding unit, thus the UAV control element 110 may restrain operations for unloading the cargo C1 from the unmanned aerial vehicle 100 such as removing the cargo C1 from the unmanned aerial vehicle 100 or taking out the cargo C1 from the transport box held by the unmanned aerial vehicle 100 and the like by the transport client. Therefore, the time for the consignee and the transit personnel of the cargo C1 to receive or transit the cargo C1 may be reduced, and the convenience may be further improved.

In addition, the transport client may also perform operations for holding the cargo C1 by the unmanned aerial vehicle 100 such as bundling the cargo C1 to the unmanned aerial vehicle 100 or placing the cargo C1 into the transport box held by the unmanned aerial vehicle 100 and the like. In addition, the consignee and the transit personnel of the cargo C1 may perform operations for unloading cargo from the unmanned aerial vehicle 100 such as removing the cargo C1 from the unmanned aerial vehicle 100 or taking out the cargo C1 from the transport box held by the unmanned aerial vehicle 100 and the like. In such way, the transport client, the consignee and the transit personnel of the cargo C1 may also assist in holding and removing the holding state of the cargo by the unmanned aerial vehicle 100.

Next, the operations of the unmanned aerial vehicle 100 when the cargo C1 is transported through the transport network CN are described.

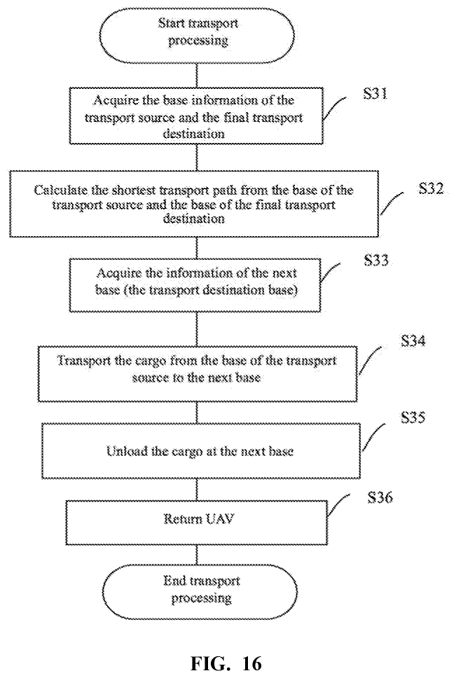

FIG. 16 illustrates a flow chart of operations of the unmanned aerial vehicle 100 when the cargo C1 is transported through the transport network CN according to some embodiments of the present disclosure. For example, the UAV control element 100 may start the processing shown in FIG. 16 by receiving the transport indication information transmitted by the mobile terminal 80 carried by the transport client. The UAV control element 100 may directly acquire the transport indication information from the mobile terminal 80 or may acquire the transport indication information through the transport server 40.

The UAV control element 110 may first acquire the position information of the base B1 of the transport source and the base B1 of the final transport destination of the cargo C1 in the mountain region M1 used as the transport region (S31). The UAV control element 110 may calculate the air passing-node B2 of the transport source after the height of the base B1 of the transport source is changed, and the air passing-node B2 of the transport source after the height of the base B1 of the final transport destination is changed.

The UAV control element 110 may calculate the shortest transport path TS (e.g., an example of the transport path T1) from the base B1 of the transport source and the base B1 of the final transport destination, and also generate the shortest transport path TS (S32). The shortest transport path TS may be the same as the shortest transport path TS from the air passing-node B2 which is located above the base B1 of the transport source and the air passing-node B2 which is located above the base B1 of the final transport destination.

The UAV control element 110 may acquire the information (e.g., the position information) of the next base B1 (e.g., the base B1 corresponding to the air passing-node B2 connected to the air passing-node B2 of the transport source through the partial transport path Tp) of the base B1 of the transport source in the shortest transport path TS (S33).

The UAV control element 110 may enable the cargo C1 of the transport subject to be aggregated. The UAV control element 110 may transport the cargo C1 from the base B1 of the transport source to the next base B1 (the base B1 of the transport destination) according the shortest transport path TS (S34). That is, the UAV control element 110 may hold the cargo C1 and perform the flight control from the base B1 of the transport source to the base b 1 of the transport destination.

When the cargo C1 arrives at the base B1 of the transport destination, the UAV control element 110 may remove the holding state of the cargo C1 and unload the cargo C1 (S35). In order to arrange a next transport in the base B1 of the transport source, the UAV control element 110 may, for example, enable the unmanned aerial vehicle 100 to be returned to the base B1 of the transport source. That is, after the cargo C1 is unloaded, the UAV control element 110 may enable the unmanned aerial vehicle 100 to fly from the base B1 of the transport destination to the base B1 of the transport source.

According to the process in FIG. 16, the unmanned aerial vehicle 100 may connect the transportable path P1 in the transport network CN and generate the transport path T1 according to the transport network CN and the information of the base B1 of the transport source and the base B1 of the final transport destination. In such case, even if the terrain of the transport region including the mountain region M1 for transporting the cargo C1 is complicated, and the transport region is large relative to the longest transport distance of the unmanned aerial vehicle 100, the unmanned aerial vehicle 100 may also adjust the length of each partial transport path Tp included in the transport path T1 as the length shorter than the length of the longest transport path of the unmanned aerial vehicle 100. Therefore, the cargo C1 may be transported by one unmanned aerial vehicle 100 between the bases B1 in the transport path T1. In addition, the unmanned aerial vehicle 100 may transport the cargo C1 according to the transport path T1 based on the transport network CN where the longest transport distance of the unmanned aerial vehicle 100 is added, which may restrain the problem that the cargo C1 may not be transported in the middle of the partial transport path Tp included in the transport path T1 due to insufficient battery of the unmanned aerial vehicle 100.

In addition, the unmanned aerial vehicle 100 may transport the cargo C1 according to the transport path T1, and the cargo C1 may not be transported on the ground using personnel and vehicles, which may reduce the costs required for transporting the cargo C1 such as labor costs and the like. Furthermore, even if a walkable road capable of reaching the transport destination of the cargo C1 is not built, the transporter in charge may use the unmanned aerial vehicle 100 to transport the cargo C1 without walking to reduce the transport danger. The unmanned aerial vehicle 100 may not depend on the ground condition and may fly along the partial transport path Tp connecting each air passing-node B2 corresponding to each base B1 in the straight line. Therefore, compared with the transport to the final transport destination through the ground, the cargo C1 may be transported over a shorter distance in the air. In addition, the unmanned aerial vehicle 100 may move freely in the three-dimensional space, thus the utilization efficiency of the three-dimensional space during the transport of the cargo C1 may be improved. Compared with the transport of the cargo C1 by a helicopter, the unmanned aerial vehicle 100 may be easier to implement stationary and large-angle maneuvers, thereby achieving the small-turn and flexible transport of the cargo C1. Moreover, the unmanned aerial vehicle 100 is smaller than the helicopter, thus the unmanned transport of the cargo C1 may be implemented to reduce costs. The cost of cargo transport using the unmanned aerial vehicle 100 may be lower than other transport methods. Therefore, even the cargo C1 is small-sized or the quantity of the cargoes C1 is small, a desirable cost-effectiveness ratio may be easily obtained.

In such way, the automation and unmanned transport of the cargo C1 (e.g., the cargo transport in the mountain region) by the unmanned aerial vehicle 100 in the complicated terrain and the large region may be implemented.

The present disclosure has been described through the embodiments, but the technical scope of the present disclosure may not be limited to the scope described in the above-mentioned embodiments. It is apparent to those skilled in the art that various modifications and variations may be made in the disclosure without departing from the spirit and scope of the disclosure. It is also apparent from the description of the claims that the embodiments added with such modifications and variations may be included in the technical scope of the present disclosure.

It should be noted that the execution orders of various processing including actions, sequences, steps, and stages in the devices, systems, programs, and methods shown in the claims, the specification and the drawings of the specification may be implemented in any order, as long as “before”, “in advance” and the like are not specifically stated, and the output of a previous processing is not used in a subsequent processing. The operation flow in the claims, the specification, and the drawings of the specification has been described using “first”, “next”, and the like for convenience, but it may not indicate that such order must be implemented.

What is claimed is:

1. An information processing device, for generating a transport network for transporting a cargo by a flying object, the device comprising:
a processing element, performing a processing related to a generation of the transport network, wherein the processing element is configured to:
acquire information of three-dimensional positions of each of a plurality of bases located on a ground in a transport region with the cargo to be transported;
by adding a predetermined height to the three-dimensional positions of each of the plurality of bases, calculate three-dimensional positions of each of a plurality of air passing-nodes for the flying object to fly through;
generate a plurality of transportable paths capable of transporting the cargo by connecting the plurality of air passing-nodes; and
generate the transport network according to the three-dimensional positions of each of the plurality of air passing-nodes and the plurality of transportable paths.

2. The device according to claim 1, wherein:
the plurality of transportable paths includes a first transportable path connecting the plurality of air passing-nodes by straight lines;
the processing element is configured to acquire three-dimensional terrain information of the transport region;
according to the three-dimensional terrain information, whether the first transportable path is in contact with the ground in the transport region is determined; and
when the first transportable path is determined to be in contact with the ground, the first transportable path is modified.

3. The device according to claim 2, wherein:
the processing element is configured to adjust a height of at least one air passing-node of two air passing-nodes connected to the first transportable path to modify the first transportable path.

4. The device according to claim 2, wherein:
the processing element is configured to modify a shape of the first transportable path according to the three-dimensional terrain information to enable the first transportable path to be conformally along the ground.

5. The device according to claim 2, wherein:
the plurality of transportable paths includes a second transportable path; and
when a length of the second transportable path is longer than a longest transport distance of the flying object, the processing element is configured to delete the second transportable path from the transport network.

6. The device according to claim 1, wherein:
the plurality of air passing-nodes includes a first air passing-node and a second air passing-node closest to the first air passing-node; and
when a distance between the first air passing-node and the second air passing-node is longer than a longest transport distance of the flying object, the processing element is configured to add a new base and a new air passing-node between the first air passing-node and the second air passing-node.

7. The device according to claim 1, wherein:
the processing element is configured to generate the plurality of transportable paths according to a three-dimensional triangulation method.

8. A flying object, associated with the information processing device according to claim 1, wherein the flying object comprises:
a processing element, performing a processing related to cargo transport, wherein the processing element is configured to:
acquire position information of a transport source and a final transport destination of the cargo;
acquire information of the transport network generated by the information processing device;
according to the transport network, the position information of the transport source and the final transport destination, generate a transport path from the transport source to the final transport destination; and
acquire position information of a transport destination of the cargo according to the transport path, thereby enabling the flying object to transport the cargo to the transport destination.

9. The object according to claim 8 wherein:
the transport path is a shortest transport path with a smallest sum value of a plurality of transportable paths included between the transport source and the final transport destination in the transport network.

10. The device according to claim 8, wherein:
the processing element is configured to enable the flying object to be returned from the transport destination to the transport source.

11. A method for generating a transport network, in an information processing device of the transport network for transporting a cargo by a flying object, comprising:
acquiring information of three-dimensional positions of each of a plurality of bases located on a ground in a transport region with the cargo to be transported;
by adding a predetermined height to the three-dimensional positions of each of the plurality of bases, calculating three-dimensional positions of each of a plurality of air passing-nodes for the flying object to fly through;
generating a plurality of transportable paths capable of transporting the cargo by connecting the plurality of air passing-nodes; and
generating the transport network according to the three-dimensional positions of each of the plurality of air passing-nodes and the plurality of transportable paths.

12. The method according to claim 11, wherein:
the plurality of transportable paths includes a first transportable path connecting the plurality of air passing-nodes by straight lines; and
the method for generating the transport network further includes:
acquiring three-dimensional terrain information of the transport region;
according to the three-dimensional terrain information, determining whether the first transportable path is in contact with the ground in the transport region; and
when the first transportable path is determined to be in contact with the ground, modifying the first transportable path.

13. The method according to claim 12 wherein:
modifying the first transportable path includes adjusting a height of at least one air passing-node of two air passing-nodes connected to the first transportable path to modify the first transportable path.

14. The method according to claim 12, wherein:
modifying the first transportable path includes modifying a shape of the first transportable path according to the three-dimensional terrain information to enable the first transportable path to be conformally along the ground.

15. The method according to claim 12, wherein:
the plurality of transportable paths includes a second transportable path; and
the method for generating the transport network further includes:
when a length of the second transportable path is longer than a longest transport distance of the flying object, deleting the second transportable path from the transport network.

16. The method according to claim 11, wherein:
the plurality of air passing-nodes includes a first air passing-node and a second air passing-node closest to the first air passing-node; and
the method for generating the transport network further includes:
when a distance between the first air passing-node and the second air passing-node is longer than a longest transport distance of the flying object, adding a new base and a new air passing-node between the first air passing-node and the second air passing-node.

17. The method according to claim 11, wherein:
generating the plurality of transportable paths includes generating the plurality of transportable paths according to a three-dimensional triangulation method.

18. A transport method, associated with a flying object for transporting a cargo, comprising:
acquiring position information of a transport source and a final transport destination of the cargo;
acquiring information of a transport network
according to the transport network, the position information of the transport source and the final transport destination, generating a transport path from the transport source to the final transport destination; and
acquiring position information of a transport destination of the cargo according to the transport path, thereby enabling the flying object to transport the cargo to the transport destination.

19. The method according to claim 18, wherein:
the transport path is a shortest transport path with a smallest sum value of a plurality of transportable paths included between the transport source and the final transport destination in the transport network.

20. The method according to claim 18, further including:
enabling the flying object to be returned from the transport destination to the transport source.
